(19) United States
(12) Patent Application Publication
(10) Pub. No.: US 2025/0299134 A1
(43) Pub. Date: Sep. 25, 2025

(54) Workflow Recommendation Method and Device

(71) Applicant: Siemens Aktiengesellschaft, München (DE)

(72) Inventors: Wen Chao Zou, Shanghai (CN); Hai Feng Wang, Shanghai (CN)

(73) Assignee: Siemens Aktiengesellschaft, München (DE)

(21) Appl. No.: 18/860,901

(22) PCT Filed: Apr. 29, 2022
(86) PCT No.: PCT/CN2022/090642

§ 371 Date: Oct. 28, 2024

(51) Int. Cl. G06Q 10/0633

(52) U.S. Cl. CPC G06Q 10/0633

(57) ABSTRACT

Various embodiments of the teachings herein include a workflow recommendation method. An example includes: receiving a current requirement entity; based on a pre-established determinate mapping between each requirement entity and each workflow entity, using the current requirement entity as a keyword to search the determinate mappings, in order to obtain at least one candidate workflow entity, where a determinate mapping has been established between this at least one candidate workflow entity and the current requirement entity; in the determinate mapping, establishing a connection between the requirement entity and the corresponding workflow entity by a “using” and “used” mapping; and recommending the candidate workflow entity.

### CROSS-REFERENCE TO RELATED APPLICATIONS

This application is a U.S. National Stage Application of International Application No. PCT/CN2022/090642 filed Apr. 29, 2022, which designates the United States of America, the contents of which are hereby incorporated by reference in their entirety.

### TECHNICAL FIELD

The present disclosure relates to the field of computers. Various embodiments of the teachings herein include workflow recommendation methods and/or devices.

### BACKGROUND

As computers have developed, requirements engineering has also developed broadly. Requirements engineering is a discipline in which technology and methods are applied to perform requirement analysis, determine customer requirements, help analysis personnel to understand problems and define all external features of a target system. Requirements engineering uses suitable tools and marks to systematically describe a system to be developed as well as its behavioral features and associated constraints, forming a requirement file and supporting the evolution of users' ever-changing requirements.

One of the objectives of requirements engineering is to generate a workflow by providing requirements such as functional requirements and descriptions of use cases. A key point in achieving this objective is to map a requirement entity (e.g. a task/use case) to a workflow entity (e.g. a component/skill/feature). A typical method is keyword mapping, in which a requirement entity and a workflow entity are marked with the same label (i.e. keyword), to create a mapping relationship therebetween.

For example, FIG. 1 shows a demonstration of keyword mapping in one example. As shown in FIG. 1, the requirement entity “performance improvement” is marked “performance monitoring” and “availability monitoring”, and the skill entity “performance analysis” is marked “performance monitoring” and “OEE monitoring”. Here, the label “performance monitoring” can match the requirement and the skill, but no match is possible with the labels “availability monitoring” and “OEE monitoring”. However, it is common knowledge that OEE (overall equipment effectiveness) may represent availability, so the two are in fact synonyms.

The requirement entity and the workflow entity are generally provided by different user groups, and different user groups might set different labels for the same meaning or set the same label for different meanings; therefore, natural language keywords such as synonyms and polysemous words will reduce the feasibility of keyword mapping. In addition, each entity might have a different granularity, and entity categories might partially overlap or be different from one another; for example, different tasks might have the same skill, and the same task might have different skills; different use cases might have the same edge application, and the same use case might have different edge applications. This makes it difficult to use a group of unified labels to mark entities correctly.

### SUMMARY

In view of the above, teachings of the present disclosure provide workflow recommendation methods, workflow recommendation devices, and computer-readable storage media, to realize workflow recommendation in requirements engineering and make workflow recommendation more flexible and efficient. For example, some embodiments include a workflow recommendation method comprising: receiving a current requirement entity; based on a pre-established determinate mapping between each requirement entity and each workflow entity, using the current requirement entity as a keyword to search the determinate mappings, in order to obtain at least one candidate workflow entity, where a determinate mapping has been established between this at least one candidate workflow entity and the current requirement entity, wherein, in the determinate mapping, a connection is established between the requirement entity and the corresponding workflow entity by a “using” and “used” mapping; and recommending the candidate workflow entity.

As another example, some embodiments include a workflow recommendation device comprising: a human-machine interaction module and a workflow entity search module, wherein: the human-machine interaction module is used to receive a current requirement entity and to provide the current requirement entity to the workflow entity search module and to recommend a candidate workflow entity from the workflow search module; the workflow entity search module is used, based on a pre-established determinate mapping between each requirement entity and each workflow entity, to search the determinate mappings using the current requirement entity as a keyword, in order to obtain at least one candidate workflow entity, where a determinate mapping has been established between this at least one candidate workflow entity and the current requirement entity, and to provide the at least one candidate workflow entity to the human-machine interaction module; in the determinate mapping, a connection is established between the requirement entity and the corresponding workflow entity by a “using” and “used” mapping.

As another example, some embodiments include a workflow recommendation device, comprising at least one memory and at least one processor, wherein: the at least one memory is used to store a computer program; the at least one processor is used to retrieve the computer program stored in the at least one memory and to perform one or more of the workflow recommendation methods described herein.

As another example, some embodiments include a computer-readable storage medium, having a computer program stored thereon; the computer program is executable by a processor and performs one or more of the workflow recommendation methods described herein.

### BRIEF DESCRIPTION OF THE DRAWINGS

To better understand the teachings of the present disclosure, examples are described in detail below with reference to the drawings, in order to give those skilled in the art a clearer understanding of the above and other features and advantages of the teachings herein. In the drawings:

FIG. 1 is a flow chart of an example workflow recommendation method incorporating teachings of the present disclosure;

FIGS. 2A and 2B each show a schematic diagram of a basic mapping between a requirement entity and a workflow entity incorporating teachings of the present disclosure;

FIG. 3A is a schematic diagram of determinate mappings from use cases to edge applications, based on the basic mapping shown in FIG. 2A;

FIG. 3B is a schematic diagram showing the search for an edge application of a current use case, based on the determinate mappings shown in FIG. 3A;

FIG. 3C is a schematic diagram showing the search for an edge application of a current task of a current use case, based on the determinate mappings shown in FIG. 3A;

FIG. 4A is a schematic diagram of determinate mappings from use cases to functional blocks, based on the basic mapping shown in FIG. 2B, incorporating teachings of the present disclosure;

FIG. 4B is a schematic diagram showing the search for a functional block of a current task of a current use case, based on the determinate mappings shown in FIG. 4A;

FIG. 5 is a structural diagram of an example workflow recommendation device incorporating teachings of the present disclosure; and

FIG. 6 is a structural diagram of an example workflow recommendation device incorporating teachings of the present disclosure.

Key to the drawings:

| Label | Meaning |
|---|---|
| 101-104 | Steps |
| EA1, EA2, EA3, EAN1 | Edge applications |
| SK1, SK2, SKN2 | Skills |
| UC1, UC2, UC3, UCN3, UCN8 | Use cases |
| T1, T2, TN4, TN7 | Tasks |
| FB1, FB2, FB3, FBN5 | Functional blocks |
| DV1, DV2, DVN6 | Devices |
| 51 | Human-machine interaction module |
| 52 | Workflow entity search module |
| 61 | Memory |
| 62 | Processor |
| 63 | Bus |

### DETAILED DESCRIPTION

Due to the fact that a determinate mapping is established between a requirement entity and a workflow entity, a determinate and accurate workflow entity can be recommended for the current requirement entity, and the efficiency and effectiveness of workflow recommendation may be improved. Because any number of determinate mappings between requirement entities and workflow entities can be realized, and expansion with new mappings is possible, feasibility, and expandability are high. Moreover, since the paradigm of the determinate mapping between a requirement entity and a workflow entity is suitable for establishing mappings between any requirement entities and workflow entities, the technical solution is versatile.

In some embodiments, to avoid various problems associated with keyword mapping, we consider establishing a determinate mapping between a requirement entity and a workflow entity and recommending a corresponding workflow entity for a current requirement entity on the basis of the determinate mapping. To clarify the objectives, technical solutions and advantages of the present disclosure, the technical solutions of the present disclosure are described in detail below through embodiments with reference to the drawings.

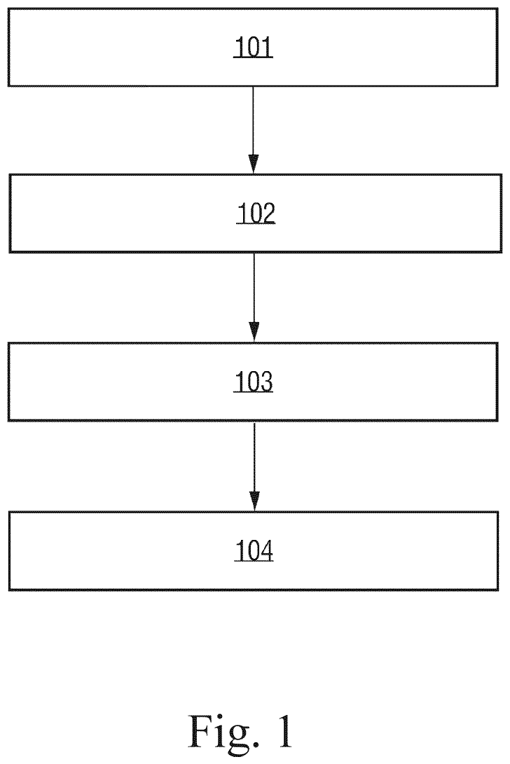

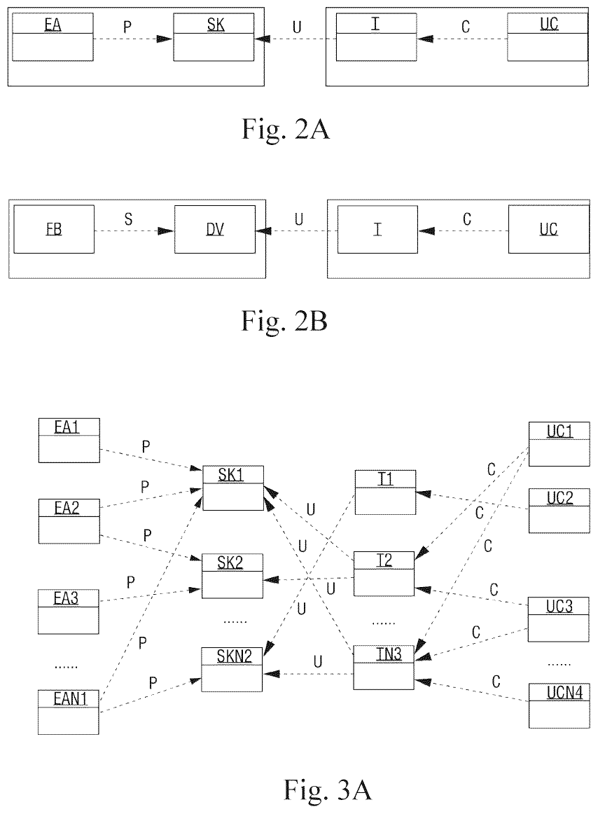

FIG. 1 is a flow chart of an example workflow recommendation incorporating teachings of the present disclosure. As shown in FIG. 1, the method may comprise:
Step 101: establishing determinate mappings between requirement entities and workflow entities in advance. In the determinate mapping, a connection is established between a requirement entity and a corresponding workflow entity by a “using” and “used” mapping. For example, FIGS. 2A and 2B each show a schematic diagram of a basic mapping between a requirement entity and a workflow entity in an example of the present application.

FIG. 2A takes as an example the case where the requirement entity comprises a use case UC and a task T and the workflow entity comprises an edge application EA and a skill SK. As shown in FIG. 2A, in the basic mapping shown in FIG. 2A, a “comprising” and “comprised” mapping is provided between the use case UC representing the requirement entity and the task T comprised in the use case UC, a “providing” and “provided” mapping is provided between the edge application EA representing the workflow entity and the skill SK provided by the edge application EA, and a “using” and “used” mapping is provided between the task T and the skill SK. In FIG. 2A, P means “provide”, C means “comprise”, and U means “use”. Here, the “comprising” and “comprised” mapping, the “providing” and “provided” mapping, and the “using” and “used” mapping are all determinate mappings.

FIG. 2B takes as an example the case where the requirement entity comprises a use case UC and a task T and the workflow entity comprises a functional block FB and a device DV. As shown in FIG. 2B, in the basic mapping shown in FIG. 2B, a “comprising” and “comprised” mapping is provided between the use case UC representing the requirement entity and the task T comprised in the use case UC, a “supporting” and “supported” mapping is provided between the functional block FB representing the workflow entity and the device DV supported by the functional block FB, and a “using” and “used” mapping is provided between the task T and the device DV. In FIG. 2B, S means “support”, C means “comprise”, and U means “use”. Here, the “comprising” and “comprised” mapping, the “supporting” and “supported” mapping, and the “using” and “used” mapping are all determinate mappings.

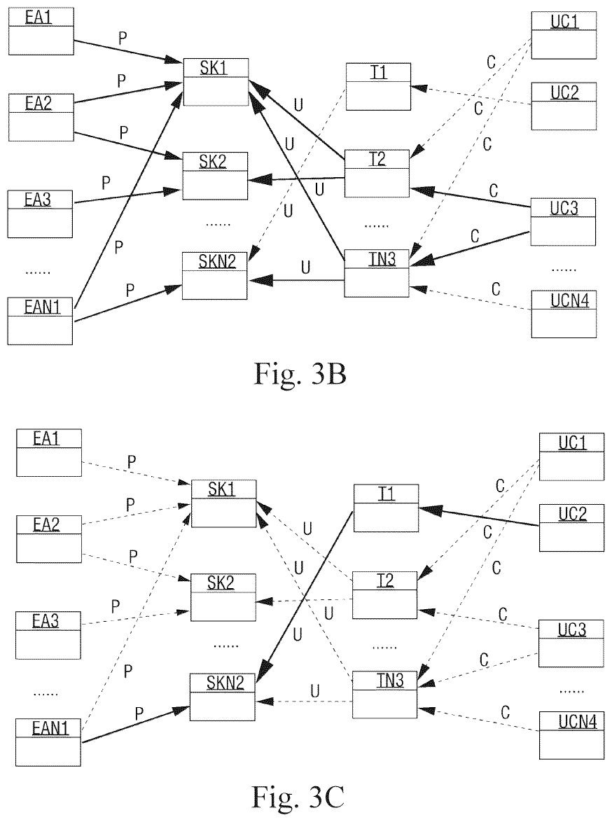

FIG. 3A shows a schematic diagram of determinate mappings from use cases to edge applications, based on the basic mapping shown in FIG. 2A, in an example. As shown in FIG. 3A, at a workflow entity side, a first edge application EA1 provides a first skill SK1; a second edge application EA2 provides the first skill SK1 and a second skill SK2; a third edge application EA3 provides the second skill SK2; . . . ; and an N1st edge application EAN1 provides the first skill SK1 and an N2nd skill SKN2. At a requirement entity side, a first use case UC1 comprises a second task T2 and an Nth task TN; a second use case UC2 comprises a first task T1; a third use case UC2 comprises the second task T2 and an N3rd task TN3; . . . ; and an N4th use case UCN4 comprises the N3rd task TN3. Between the workflow entity and the requirement entity, the first task T1 uses the N2nd skill SKN2; the second task T2 uses the first skill SK1 and the second skill SK2; and the N3rd task TN3 uses the first skill SK1. In FIG. 3A, P means “provide”, C means “comprise”, and U means “use”. As can be seen, by means of such determinate mappings, it is possible to connect different edge applications having various skills and different use cases having various tasks.

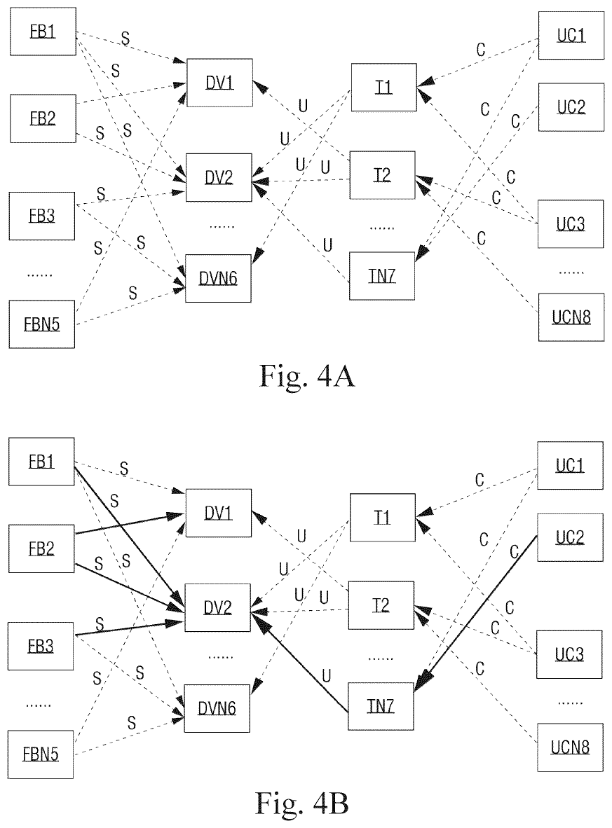

FIG. 4A shows a schematic diagram of determinate mappings from use cases to functional blocks, based on the basic mapping shown in FIG. 2B, in an example. As shown in FIG. 4A, at a workflow entity side, a first functional block FB1 supports a first device DV1, a second device DV2 and an N6th device DVN6; a second functional block FB2 supports the first device DV1 and the second device DV2; a third functional block FB3 supports the second device DV2 and an N6th device DVN6; . . . ; and an N5th functional block FBN5 supports the first device DV1 and the N6th device DVN6. At a requirement entity side, a first use case UC1 comprises a first task T1 and an N7th task TN7; a second use case UC2 comprises an N7th task TN7; a third use case UC2 comprises the first task T1 and a second task T2; . . . ; and an N8th use case UCN8 comprises the second task T2. Between the workflow entity and the requirement entity, the first task T1 uses the second device DV2 and the N6th device DVN6; the second task T2 uses the first device DV1 and the second device DV2; and the N7th task TN7 uses the second device DV1. In FIG. 4A, S means “support”, C means “comprise”, and U means “use”. As can be seen, by means of such determinate mappings, it is possible to connect different functional blocks supporting various devices and different use cases having various tasks.

In some embodiments, the determinate mappings between the requirement entities and the workflow entities may be created by a workflow provider according to various application requirements and requirement entities provided by a requirement provider and various workflow entities provided by the workflow provider, or may be created by a requirement provider according to various workflow entities provided by a workflow provider and various application requirements and requirement entities of the requirement provider, or may be created by a third party according to various application entities provided by a requirement provider and various workflow entities provided by a workflow provider. No restrictions are imposed in this respect here.
Step 102: receiving a current requirement entity. The current requirement entity may be provided by any user, who may for example be a requirement provider in an actual application, or another user of a test system, etc.

Taking as an example the basic mappings shown in FIGS. 2A and 2B, a current use case representing the current requirement entity, or a current task of the current use case, may be received in this step. For example, in the case of the determinate mapping shown in FIG. 3A, the current requirement entity may be the third use case UC3 (i.e. the current use case), or may be the first task T1 of the second use case UC2 (i.e. the current task of the current use case), etc. As another example, in the case of the determinate mapping shown in FIG. 4A, the current requirement entity may be the second use case UC2 (i.e. the current use case), or may be the N7th task TN7 of the second use case UC2 (i.e. the current task of the current use case).
Step 103: based on the determinate mappings between the requirement entities and the workflow entities, using the current requirement entity as a keyword to search the determinate mappings, in order to obtain a candidate workflow entity, where a determinate mapping has been established between this candidate workflow entity and the current requirement entity. Generally, at least one candidate workflow entity may be obtained. Taking as an example the determinate mappings shown in FIGS. 2A and 3A, in this step the current use case or the current task of the current use case may be used as a keyword to search the determinate mappings, in order to obtain a candidate edge application providing the skill used by the current use case or the current task of the current use case.

The specific query process may be as follows:
Find [Edge Apps], Condition with {; search for [edge applications] which meet the following conditions:
1. [Edge Apps] provide [Skills]&&; [edge applications] provide [skills], and
2. [Skills] are used by [Tasks]&&; [skills] are used by [tasks], and
3. [Tasks] are contained in [Use Cases]; [tasks] are contained in [use cases].
}

In the case where the current requirement entity is the third use case UC3, the following query process may be used:
Find [Edge Apps], Condition with {; search for [edge applications] which meet the following conditions:
1. [Edge Apps] provide [Skills]&&; [edge applications] provide [skills], and
2. [Skills] are used by [Tasks]&&; [skills] are used by [tasks], and
3. [Tasks] are contained in <UC3>; [tasks] are contained in [third use case].
}

Correspondingly, as indicated by the solid line parts in FIG. 3B, the first edge application EA1, the second edge application EA2, the third edge application EA3 and the N1st edge application EAN1 will be obtained.

In the case where the current requirement entity is the first task T1 of the second use case UC2, the following query process may be used:

Find [Edge Apps], Condition with {; search for [edge applications] which meet the following conditions:
1. [Edge Apps] provide [Skills]&&; [edge applications] provide [skills], and
2. [Skills] are used by [T1]&&; [skills] are used by [first task], and
3. [T1] are contained in <UC2>; [first task] is contained in [second use case].
}

Correspondingly, as indicated by the solid line parts in FIG. 3C, the N1st edge application EAN1 will be obtained. Taking as an example the determinate mappings shown in FIGS. 2B and 4A, in this step the current use case or the current task of the current use case may be used as a keyword to search the determinate mappings, in order to obtain a candidate functional block supporting the device used by the current use case or the current task of the current use case.

The specific query process may be as follows:
Find [Function Blocks], Condition with {; search for [functional blocks] which meet the following conditions:
1. [Function Blocks] support [Devices] & &; [functional blocks] support [devices], and
2. [Devices] are used by [Tasks]&&; [devices] are used by [tasks], and
3. [Tasks] are contained in [Use Cases]; [tasks] are contained in [use cases].
}

In the case where the current requirement entity is the second use case UC2, the following query process may be used:
Find [Function Blocks], Condition with {; search for [functional blocks] which meet the following conditions:
1. [Function Blocks] support [Devices]&&; [functional blocks] support [devices], and
2. [Devices] are used by [Tasks]&&; [devices] are used by [tasks], and
3. [Tasks] are contained in <UC2>; [tasks] are contained in [second use case].
}

Correspondingly, as indicated by the solid line parts in FIG. 4B, the first functional block FB1, the second functional block FB2 and the third functional block FB3 will be obtained.

In the case where the current requirement entity is the N7th task TN7 of the second use case UC2, the following query process may be used:
Find [Function Blocks], Condition with {; search for [functional blocks] which meet the following conditions:
1. [Function Blocks] support [Devices]&&; [functional blocks] support [devices], and
2. [Devices] are used by [TN7]&&; [devices] are used by [N7th task], and
3. [TN7] are contained in <UC2>; [N7th task] is contained in [second use case].
}

Correspondingly, since the second use case contains only one task, i.e. the N7th task TN7, when using the second use case or the N7th task of the second use case as a keyword to search the determinate mappings shown in FIG. 4A, the same search result will be obtained, i.e., as indicated by the solid line parts in FIG. 4B, the first functional block FB1, the second functional block FB2 and the third functional block FB3 will be obtained.
Step 104: recommending the candidate workflow entity.

In the case of the determinate mappings shown in FIGS. 2A and 3A, in this embodiment the candidate edge application may be recommended as a workflow corresponding to the current requirement entity.

In the case of the determinate mappings shown in FIGS. 2B and 4A, in this embodiment the candidate functional block may be recommended as a workflow corresponding to the current requirement entity.

In order to enable persistent mapping expansion and updating of the determinate relationships to be maintained, if it is determined, after using a current requirement entity as a keyword to search the determinate mappings, that the current requirement entity is not in the determinate mappings, then the current requirement entity may be provided to a determinate mapping builder, and the determinate mapping builder then maps the current requirement entity to an existing workflow entity or a new workflow entity, forms a new mapping record and updates the determinate mappings with the new mapping record. For example, in the case of the determinate mappings shown in FIGS. 2A and 3A, if it is determined, after using the current use case or the current task of the current use case as a keyword to search the determinate mappings, that the current use case or the current task of the current use case is not in the determinate mappings, then the current use case or the current task of the current use case is provided to a determinate mapping builder, and the determinate mapping builder then maps the current use case or the current task of the current use case to a new skill or an existing skill of an existing edge application or to a skill provided by a new edge application, forms a new mapping record and updates the determinate mappings with the new mapping record. As another example, in the case of the determinate mappings shown in FIGS. 2B and 4A, if it is determined, after using the current use case or the current task of the current use case as a keyword to search the determinate mappings, that the current use case or the current task of the current use case is not in the determinate mappings, then the current use case or the current task of the current use case is provided to a determinate mapping builder, and the determinate mapping builder then maps the current use case or the current task of the current use case to a new device or an existing device supported by an existing functional block or to a device supported by a new functional block, forms a new mapping record and updates the determinate mappings with the new mapping record.

Of course, a requirement provider could also persistently propose new requirement entities, in which case a determinate mapping builder maps the new requirement entities to an existing workflow entity or a new workflow entity, forms a new mapping record and updates the determinate mappings with the new mapping record.

In addition, to give the determinate relationships learning ability and maintain persistent mapping rank updating, in an embodiment of the present invention, a selection result of selection by a user from among the candidate workflow entities may be received, and a weighting of a mapping between the candidate workflow entity selected by the user and the current requirement entity may be increased according to the selection result. Further, a weighting of a mapping between a candidate workflow entity not selected by the user and the current requirement entity may be decreased according to the selection result.

Specifically, in the case of the determinate mappings shown in FIGS. 2A and 3A, a selection result of selection by a user from among the candidate edge applications may be received; and a weighting of a mapping between the candidate edge application selected by the user and the current requirement entity may be increased according to the selection result. Further, a weighting of a mapping between a candidate edge application not selected by the user and the current requirement entity may be decreased according to the selection result. In the case of the determinate mappings shown in FIGS. 2B and 4A, a selection result of selection by a user from among the candidate functional blocks may be received; and a weighting of a mapping between the candidate functional block selected by the user and the current requirement entity may be increased according to the selection result. Further, a weighting of a mapping between a candidate functional block not selected by the user and the current requirement entity may be decreased according to the selection result.

For example, an initial weighting, e.g. 100%, may be set for each newly established determinate mapping between requirement entities and workflow entities. When a user receives a recommended candidate workflow entity, the user may select or deselect one or more recommended workflow entities. If a workflow entity is selected, then a reward may be fed back to a mapping between the selected workflow entity and the inputted requirement entity. A simple reward equation is shown in formula (1) below:

$${R}_{updated} = {R}_{current} + {Award}^{n} \% \leq 100 \% \qquad ( 1 )$$

The 100% on the right-hand side in formula (1) is used to define the maximum value of the weighting as 100%.

Further, if a workflow entity is not selected, then a penalty may be fed back to a mapping between the selected workflow entity and the inputted requirement entity. A simple penalty equation is shown in formula (2) below:

$${R}_{updated} = {R}_{current} - {Award}^{m} \% > 0 \% \qquad ( 2 )$$

The 0% on the right-hand side in formula (2) is used to define the minimum value of the weighting as 0%.

Rcurrent is the current weighting, Rupdated is the updated weighting, Award is a reward/penalty coefficient greater than 1, n is the number of times the user makes a selection, and m is the number of times the user does not make a selection.

Various example workflow recommendation methods incorporating teachings of the present disclosure have been described in detail above; example workflow recommendation devices will be described in detail below. The workflow recommendation devices may be used to implement the workflow recommendation methods; for details not disclosed in device the embodiments, the corresponding descriptions in the method embodiments may be referred to.

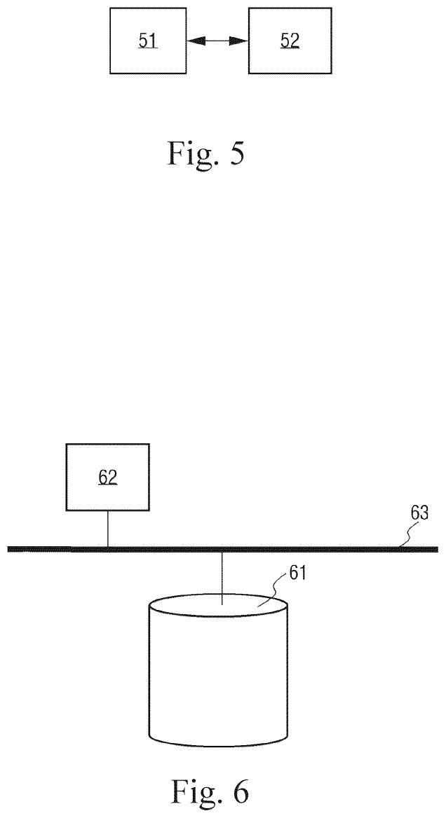

FIG. 5 is a structural diagram of an example workflow recommendation device incorporating teachings of the present disclosure. As shown in FIG. 5, the device may comprise: a human-machine interaction module 51 and a workflow entity search module 52.

The human-machine interaction module is used to receive a current requirement entity, to provide the current requirement entity to the workflow entity search module 52 and to recommend a candidate workflow entity from the workflow search module 52. The workflow entity search module 52 is used, based on a pre-established determinate mapping between each requirement entity and each workflow entity, in order to search the determinate mappings using the current requirement entity as a keyword, in order to obtain at least one candidate workflow entity, where a determinate mapping has been established between this at least one candidate workflow entity and the current requirement entity, and to provide the at least one candidate workflow entity to the human-machine interaction module 51. In the determinate mapping, a connection is established between the requirement entity and the corresponding workflow entity by a “using” and “used” mapping.

In the determinate mappings shown in FIGS. 2A and 3A, a “comprising” and “comprised” mapping is provided between a use case representing a requirement entity and a task comprised in the use case, a “providing” and “provided” mapping is provided between an edge application representing a workflow entity and a skill provided by the edge application, and a “using” and “used” mapping is provided between the task and the skill.

In the determinate mappings shown in FIGS. 2B and 4A, a “comprising” and “comprised” mapping is provided between a use case representing a requirement entity and a task comprised in the use case, a “supporting” and “supported” mapping is provided between a functional block representing a workflow entity and a device supported by the functional block, and a “using” and “used” mapping is provided between the task and the device.

In some embodiments, upon receiving a search failure indication from the workflow entity search module 52 (including not receiving a candidate edge application from the workflow entity search module 52 within a set time), the human-machine interaction module 51 may provide the current requirement entity to a determinate mapping builder, and the determinate mapping builder then maps the current requirement entity to an existing workflow entity or a new workflow entity, forms a new mapping record and provides the new mapping record to the workflow entity search module 52, and the workflow entity search module 52 updates the determinate mappings with the new mapping record.

In some embodiments, the human-machine interaction module 51 further receives a selection result of selection by a user from the candidate workflow entity and provides the selection result to the workflow entity search module 52; the workflow entity search module 52 is further used for increasing a weighting of a mapping between the candidate workflow entity selected by the user and the current requirement entity according to the selection result. Further, the workflow entity search module 52 may also decrease a weighting of a mapping between a candidate workflow entity not selected by the user and the current requirement entity according to the selection result.

In fact, the workflow recommendation device provided in such embodiments of the present application may be specifically implemented in various ways. For example, an application programming interface conforming to specific rules may be used to compile the workflow recommendation device as a plugin installed in a smart terminal, or the workflow recommendation device may be packaged in an application program for a user to download and use.

When complied as a plugin, the workflow recommendation device may be realized in various plugin forms, such as ocx, dll and cab. The workflow recommendation device provided in such embodiments of the present application may also be realized using specific technologies, such as Flash plugin technology, RealPlayer plugin technology, MMS plugin technology, MIDI people plugin technology or ActiveX plugin technology.

The workflow recommendation methods provided may be stored in various storage media by instruction storage or instruction set storage. These storage media include but are not limited to: floppy disks, optical disks, DVDs, hard disks, flash memories, USB flash memories, CF cards, SD cards, MMC cards, SM cards, memory sticks and xD cards. In addition, the workflow recommendation methods may also be applied to storage media based on flash memory (Nand-flash), such as USB flash memory drives, CF cards, SD cards, SDHC cards, MMC cards, SM cards, memory sticks and xD cards.

It should be clear that an operating system operating in a computer can realize some or all actual operations not only by executing program code read from a storage medium by the computer, but also by using instructions based on program code in order to realize the functions of any one of the embodiments above.

For example, FIG. 6 is a structural diagram of an example workflow recommendation device incorporating teachings of the present disclosure. The device may be used to perform the method shown in FIG. 1, or to realize the device in FIG. 5. As shown in FIG. 6, the device may comprise at least one memory 61 and at least one processor 62. In addition, it may also comprise other components, such as a communication port, an input/output controller, a network communication interface, etc. These components communicate via a bus 63, etc.

The at least one memory 61 is used to store a computer program. In an example, the computer program may be understood to comprise the modules of the device shown in FIG. 5. In addition, the at least one memory 61 may store an operating system, etc. Operating systems include but are not limited to: Android operating systems, Symbian operating systems, Windows operating systems, Linux operating systems, etc.

The at least one processor 62 is used to retrieve the computer program stored in the at least one memory 61, so as to perform the workflow recommendation method described in examples of the present application. The processor 62 may be a CPU, a processing unit/module, an ASIC, a logic module or a programmable gate array, etc. and may receive and send data via a communication port.

The input/output controller has a display and an input device, for inputting, outputting and displaying relevant data as a human-machine interaction module.

It should be understood that, as used herein, “and/or” is intended to include any and all possible combinations of one or more of the associated items listed.

The number of embodiments of the present application is merely intended for description purposes and does not represent advantages of embodiments.

The above are merely example embodiments of the present disclosure, which are not intended to limit it; any modifications, equivalent substitutions or improvements, etc. made within the spirit and principles of the present disclosure shall be included in the scope of protection thereof.

What is claimed is:

1. A workflow recommendation method comprising:
receiving a current requirement entity;
based on a pre-established determinate mapping between each requirement entity and each workflow entity, using the current requirement entity as a keyword to search the determinate mappings, in order to obtain at least one candidate workflow entity, where a determinate mapping has been established between this at least one candidate workflow entity and the current requirement entity;
in the determinate mapping, establishing a connection between the requirement entity and the corresponding workflow entity by a “using” and “used” mapping; and
recommending the candidate workflow entity.

2. The workflow recommendation method as claimed in claim 1, wherein:
each said requirement entity comprises a use case and a task;
each said workflow entity comprises an edge application and a skill;
the current requirement entity comprises a current use case or a current task of a current use case;
in the determinate mapping, a “comprising” and “comprised” mapping is provided between a use case representing a requirement entity and a task comprised in the use case, a “providing” and “provided” mapping is provided between an edge application representing a workflow entity and a skill provided by the edge application, and a “using” and “used” mapping is provided between the task and the skill; and
using the current requirement entity as a keyword to search the determinate mappings comprises using the current use case or the current task of the current use case as a keyword to search the determinate mappings to obtain at least one candidate edge application providing a skill used by the current use case or the current task of the current use case.

3. The workflow recommendation method as claimed in claim 2, wherein:
using the current use case as a keyword to search the determinate mappings comprises
searching for [edge applications] which meet the following conditions:
[edge applications] provide [skills], and
[skills] are used by [tasks], and
[tasks] are included in [current use case]; and
using the current task of the current use case as a keyword to search the determinate mappings comprises
searching for [edge applications] which meet the following conditions:
[edge applications] provide [skills], and
[skills] are used by [current task], and
[current task] is included in [current use case].

4. The workflow recommendation method as claimed in claim 1, wherein:
each said requirement entity comprises a use case and a task;
each said workflow entity comprises a functional block and a device; and
the current requirement entity comprises a current use case or a current task of a current use case;
in the determinate mapping, a “comprising” and “comprised” mapping is provided between a use case representing a requirement entity and a task comprised in the use case, a “supporting” and “supported” mapping is provided between a functional block representing a workflow entity and a device supported by the functional block, and a “using” and “used” mapping is provided between the task and the device;
using the current requirement entity as a keyword to search the determinate mappings to obtain a workflow entity comprises using the current use case or the current task of the current use case as a keyword to search the determinate mappings to obtain at least one candidate functional block supporting a device used by the current use case or the current task of the current use case.

5. The workflow recommendation method as claimed in claim 4, wherein:
using the current use case as a keyword to search the determinate mappings comprises
searching for [functional blocks] which meet the following conditions:
[functional blocks] support [devices], and
[devices] are used by [tasks], and
[tasks] are included in [current use case]; and
using the current task of the current use case as a keyword to search the determinate mappings comprises:
searching for [functional blocks] which meet the following conditions:
[functional blocks] support [devices], and
[devices] are used by [current task], and
[current task] is included in [current use case].

6. The workflow recommendation method as claimed in claim 1, further comprising upon determining, after using the current requirement entity as a keyword to search the determinate mappings, that the current requirement entity is not in the determinate mappings, providing the current requirement entity to a determinate mapping builder; and
Wherein the determinate mapping builder maps the current requirement entity to an existing workflow entity or a new workflow entity, forms a new mapping record, and updates the determinate mappings with the new mapping record.

7. The workflow recommendation method as claimed in claim 1, further comprising:
receiving a selection result of selection by a user from the candidate workflow entity; and
increasing a weighting of a mapping between a candidate workflow entity selected by the user and the current requirement entity according to the selection result.

8. The workflow recommendation method as claimed in claim 7, further comprising decreasing a weighting of a mapping between a candidate workflow entity not selected by the user and the current requirement entity according to the selection result.

9. A workflow recommendation device comprising:
a human-machine interaction module; and
a workflow entity search module;
wherein the human-machine interaction module receives a current requirement entity, provides the current requirement entity to the workflow entity search module, and recommends a candidate workflow entity from the workflow search module; and
the workflow entity search module, based on a pre-established determinate mapping between each requirement entity and each workflow entity, searches the determinate mappings using the current requirement entity as a keyword to obtain at least one candidate workflow entity, where a determinate mapping has been established between this at least one candidate workflow entity and the current requirement entity, and provides the at least one candidate workflow entity to the human-machine interaction module;
in the determinate mapping, a connection is established between the requirement entity and the corresponding workflow entity by a “using” and “used” mapping.

10. The workflow recommendation device as claimed in claim 9, wherein:
each said requirement entity comprises a use case and a task;
each said workflow entity comprises an edge application and a skill; and
the current requirement entity comprises a current use case or a current task of a current use case;
in the determinate mapping, a “comprising” and “comprised” mapping is provided between a use case representing a requirement entity and a task comprised in the use case, a “providing” and “provided” mapping is provided between an edge application representing a workflow entity and a skill provided by the edge application, and a “using” and “used” mapping is provided between the task and the skill;
the workflow entity search module uses the current use case or the current task of the current use case as a keyword to search the determinate mappings to obtain at least one candidate edge application providing a skill used by the current use case or the current task of the current use case.

11. The workflow recommendation device as claimed in claim 9, wherein:
each said requirement entity comprises a use case and a task;
each said workflow entity comprises a functional block and a device; and
the current requirement entity comprises a current use case or a current task of a current use case;
in the determinate mapping, a “comprising” and “comprised” mapping is provided between a use case representing a requirement entity and a task comprised in the use case, a “supporting” and “supported” mapping is provided between a functional block representing a workflow entity and a device supported by the functional block, and a “using” and “used” mapping is provided between the task and the device; and
the workflow entity search module uses the current use case or the current task of the current use case as a keyword to search the determinate mappings, in order to obtain at least one candidate functional block supporting a device used by the current use case or the current task of the current use case.

12. The workflow recommendation device as claimed in claim 9, wherein, upon receiving a search failure indication from the workflow entity search module, the human-machine interaction module provides the current requirement entity to a determinate mapping builder, and the determinate mapping builder then maps the current requirement entity to an existing workflow entity or a new workflow entity, forms a new mapping record and provides the new mapping record to the workflow entity search module, so that the workflow entity search module updates the determinate mappings with the new mapping record.

13. The workflow recommendation device as claimed in claim 9, wherein:
the human-machine interaction module receives a selection result of selection by a user from the candidate workflow entity and provides the selection result to the workflow entity search module;
the workflow entity search module increases a weighting of a mapping between a candidate workflow entity selected by the user and the current requirement entity, and decreases a weighting of a mapping between a candidate workflow entity not selected by the user and the current requirement entity, according to the selection result.

14. A workflow recommendation device, comprising:
a memory storing a computer program; and
at least one processor used to retrieve the computer program stored in the memory and execute the computer program, the program including:
receiving a current requirement entity;
based on a pre-established determinate mapping between each requirement entity and each workflow entity, using the current requirement entity as a keyword to search the determinate mappings, in order to obtain at least one candidate workflow entity, where a determinate mapping has been established between this at least one candidate workflow entity and the current requirement entity;
in the determinate mapping, establishing a connection between the requirement entity and the corresponding workflow entity by a “using” and “used” mapping; and
recommending the candidate workflow entity.

15. (canceled)
